(19) United States
(12) Patent Application Publication
(10) Pub. No.: US 2016/0024816 A1
(43) Pub. Date: Jan. 28, 2016

(54) VEHICLE CONSOLE SECURITY SYSTEM WITH ELECTRICALLY LOCKABLE COVER

(71) Applicant: FORD GLOBAL TECHNOLOGIES, LLC, Dearborn, MI (US)

(72) Inventors: Scott Simon, Dexter, MI (US); Jeremy Gene Thurman, St. Clair Shores, MI (US)

(21) Appl. No.: 14/340,849

(22) Filed: Jul. 25, 2014

(51) Int. Cl. E05B 47/00; B60R 7/04

(52) U.S. Cl. CPC E05B 47/0012; B60R 7/04

(57) ABSTRACT

The vehicle console security system includes a console having a body, a cover and an internal compartment. The cover is displaceable between a closed position closing the internal compartment and an open position allowing access to the internal compartment. An electronic locking assembly mounted to the cover locks the cover in the closed position.

### TECHNICAL FIELD

This document relates generally to vehicle consoles and, more particularly, to a vehicle console with an electrically lockable cover providing enhanced security.

### BACKGROUND

It is very desirable to provide secure storage options in the interiors of motor vehicles. This is especially important for convertible vehicles where the vehicle interior is readily accessible. Conventional solutions offer keyed locks in the latch systems of interior compartment doors, such as the cover or armrest of center consoles and glove box doors. However, vehicles have recently migrated toward keyless systems and conventional key locks for secured storage are inconsistent with this movement as they require the operator to manage and handle a key to use the lock feature. Frequently the key in a keyless locking system is stored in the key fob and is intended to be used only for emergency access. Thus, it is not readily available for use in locking and unlocking an interior compartment or door cover.

This document relates to a vehicle console security system incorporating an electronic locking assembly that may be enabled, operated and disabled by the vehicle operator utilizing a selected password thereby providing enhanced security and absolutely keyless operation consistent with modern keyless vehicle systems.

### SUMMARY

In accordance with the purposes and benefits described herein, a vehicle console security system is provided comprising a console including a body, a cover and an integral compartment. The cover is displaceable between a closed position closing the internal compartment and an open position allowing access to the internal compartment. An electronic locking assembly is mounted to the cover and locks the cover in the closed position.

The locking assembly includes an electronic actuator and a latch. In one possible embodiment the latch is a rotary latch pawl. In one possible embodiment the latch includes a spring for biasing the rotary latch pawl into a latched position. Further in one possible embodiment a paddle is carried on the latch. The paddle allows one to release the rotary latch pawl and open a cover.

An electronic actuator is connected to a blocking element that is displaceable by the actuator between a locked position and an unlocked position. In the locked position the blocking element engages the paddle so as to prevent release of the rotary latch pawl and the opening of the cover.

In one possible embodiment the electronic actuator is a linear actuator housed within a cavity on an underside of the cover. In one possible embodiment the cover is an armrest.

In one possible embodiment a guide cam is mounted to the body and a cooperating guide rail is provided on the blocking element. In one possible embodiment the blocking element includes two parallel projecting guide rails that engage two cooperating guide cams and two aligned projecting stops that engage the rotary latch pawl or paddles on the rotary latch pawl.

In one possible embodiment the system includes a shroud for holding and capturing the latch between the shroud and the cover. In this embodiment the guide cam or guide cams may be provided on the shroud.

In one possible embodiment the actuator is operably connected to a control module. The control module includes a computing device. Further the control module may include a speech processor allowing voice commands to lock and unlock the cover. Further the control module may include a human interface allowing an operator to enter a code to lock and unlock the cover. Such a human interface may comprise a monitor including a touchscreen for entering the code.

In any of the possible embodiment the electronic lock assembly may be fully concealed from view when the cover is in the closed position.

In the following description, there is shown and described several preferred embodiments of the vehicle console security system. As it should be realized, the vehicle console security system is capable of other, different embodiments and its several details are capable of modification in various, obvious aspects all without departing from the system as set forth and described in the following claims. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the vehicle console security system and together with the description serve to explain certain principles thereof. In the drawings:

FIG. 1 is a perspective view of the vehicle console security system with the cover in the closed position.

FIG. 2 is a detailed perspective view illustrating the portion of the latch pawl which engages the latch striker to lock the cover in the closed position and the hinge mechanism for pivotally securing the cover to the body of the console.

FIG. 3 is a detailed perspective view illustrating the latch striker provided on the body of the console.

FIG. 4 is an exploded perspective view of the electronic locking assembly that is mounted to the cover.

FIG. 5 is a detailed view of the electronic locking assembly housed within a cavity on an underside of the cover wherein the assembly is in the unlocked position.

FIG. 6 is a detailed perspective view illustrating the translation of the blocking element to the locked position beneath one of the paddles on the rotary latch pawl.

FIG. 6a is a detailed cross-sectional illustration of the structure for guiding the blocking element as it translates between the unlocked and locked positions.

FIG. 7 is a detailed view illustrating the electronic locking assembly in the locked position.

FIG. 8 is a detailed cross-sectional view also illustrating the assembly in the locked position.

FIG. 9 is a schematical block diagram of the control system for the electronic locking assembly.

Reference will now be made in detail to the present preferred embodiments of the vehicle console security system, examples of which are illustrated in the accompanying drawings.

### DETAILED DESCRIPTION

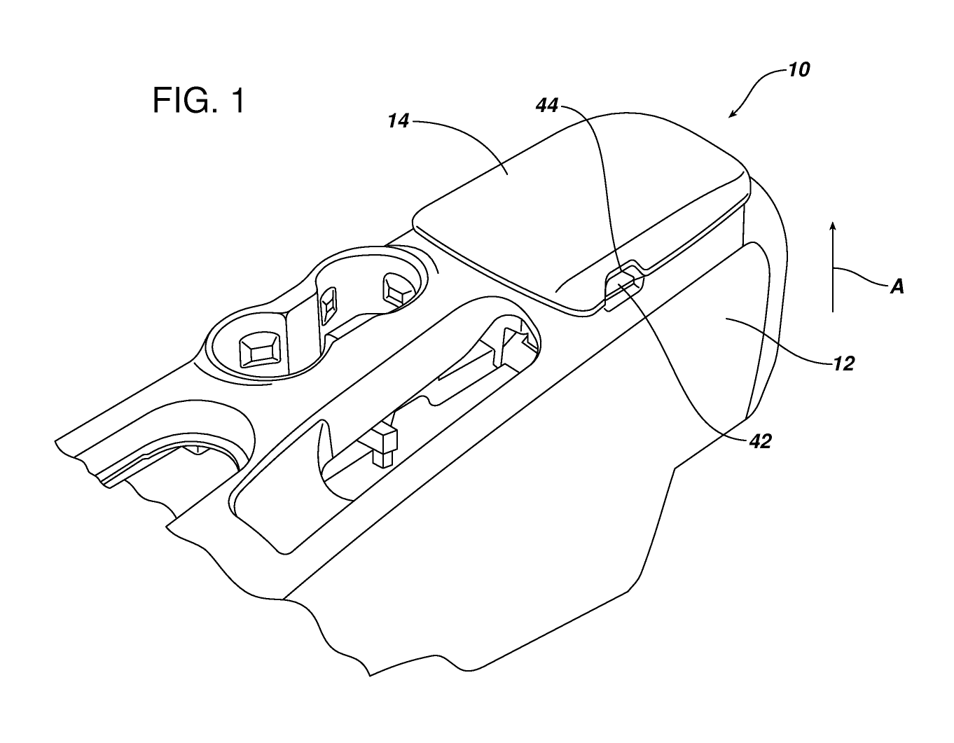

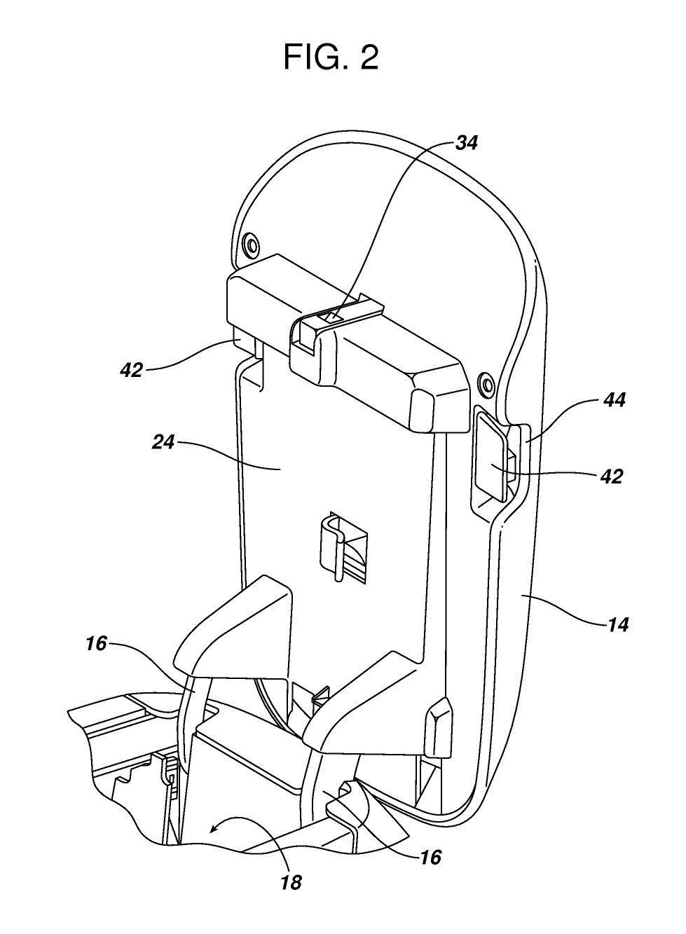

Reference is now made to FIG. 1 illustrating a vehicle console 10 having a body 12 and a cover 14. As illustrated in FIG. 2, the cover 14 is pivotally mounted to the body 12 by means of the hinge 16. Thus, the cover 14 is pivotally displaceable between the closed position illustrated in FIG. 1 and the open position illustrated in FIG. 2. When the cover 14 is in the open position an operator may access the interior compartment 18 provided in the console body 12.

As illustrated in FIGS. 2-7, an electronic locking assembly 20 is provided in a cavity 22 in the cover 14 behind an interior cover panel 24. The electronic locking assembly 20 comprises an actuator 26, a latch 28, a blocking element 30 and a shroud 32.

In the illustrated embodiment, the actuator 26 comprises a gear motor linear actuator similar to the type utilized inside doors for the door locks of motor vehicles. Such a gear motor linear actuator 26 is immune to inertial effects which would be encountered in a crash or high-G situation. Accordingly, the locking assembly 20 will not engage or disengage spontaneously when high-G forces are encountered.

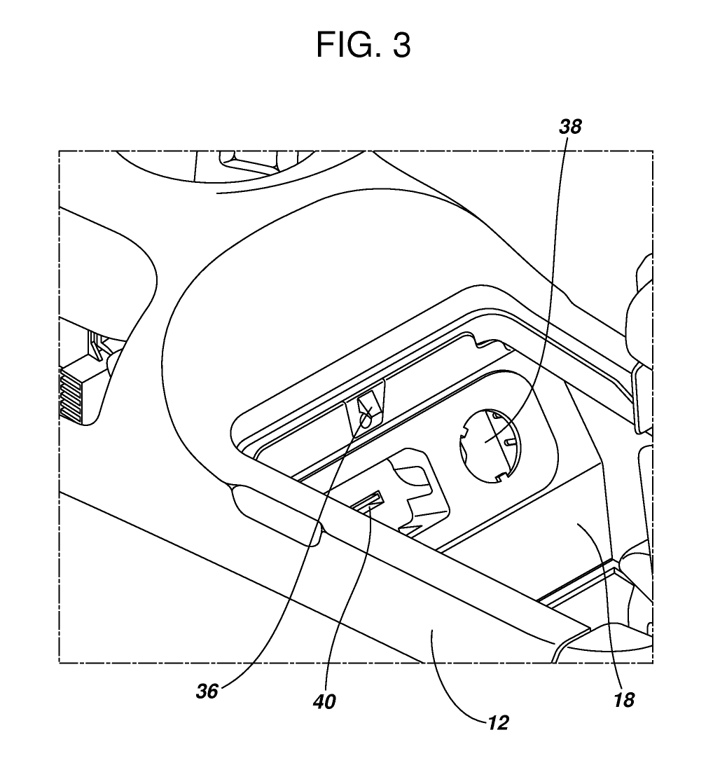

A latch 28 comprises a rotary latch pawl including a projecting pawl 34 which engages and latches to a latch striker 36 carried on the console body 12 (see FIG. 3) when the cover 14 is in the closed position. As also illustrated in FIG. 3, the interior compartment 18 of the console 10 may be equipped with a DC power outlet 38 and an electronic device port such as a USB port 40.

As further illustrated, the latch 28 also includes two projecting paddles 42 which are aligned with recesses 44 provided in the cover 14 so that they may be easily engaged with the fingers and manipulated by the operator to release the pawl 34 from the latch striker 36 and open the cover when the electronic locking assembly 20 is in the unlocked position.

The blocking element 30 includes a first lug 46 that is connected to the actuator arm 48 of the actuator 26. Further, the blocking element 30 includes two, parallel projecting guide rails 50 opposite the lug 46 and two aligned projecting stop 52 that project in opposite directions at an angle perpendicular to the guide rails 50. As will be described in greater detail below, when the blocking element 30 is in the locking position, the stops 52 engage the rotary latch 28 adjacent the paddles 42 to prevent the release of the pawl 34 from the latch striker 36 and the opening the cover 14.

The latch 28 is mounted in the aligned grooves 54 in the reinforcing ribs 56 provided along the interior surface of the exterior wall of the cover 14. The shroud 32 overlies the rotary latch 28 and functions to capture the rotary latch in the grooves 54 so that the rotary latch pivots about the integral axle 60. The shroud 32 may be secured in position by tabs 62 received in mating clips 64 on the cover 14 and screw fasteners (not shown) received in the apertures 65 on the shroud and the screw bosses 66 provided on the cover. When properly secured in position, the projecting pawl 34 provided on the latch 28 extends through the aperture 68 in the shroud 32. A leaf spring (not shown) biases the rotary latch 28 into a position to engage the latch striker 38 when the cover 14 is in the closed position.

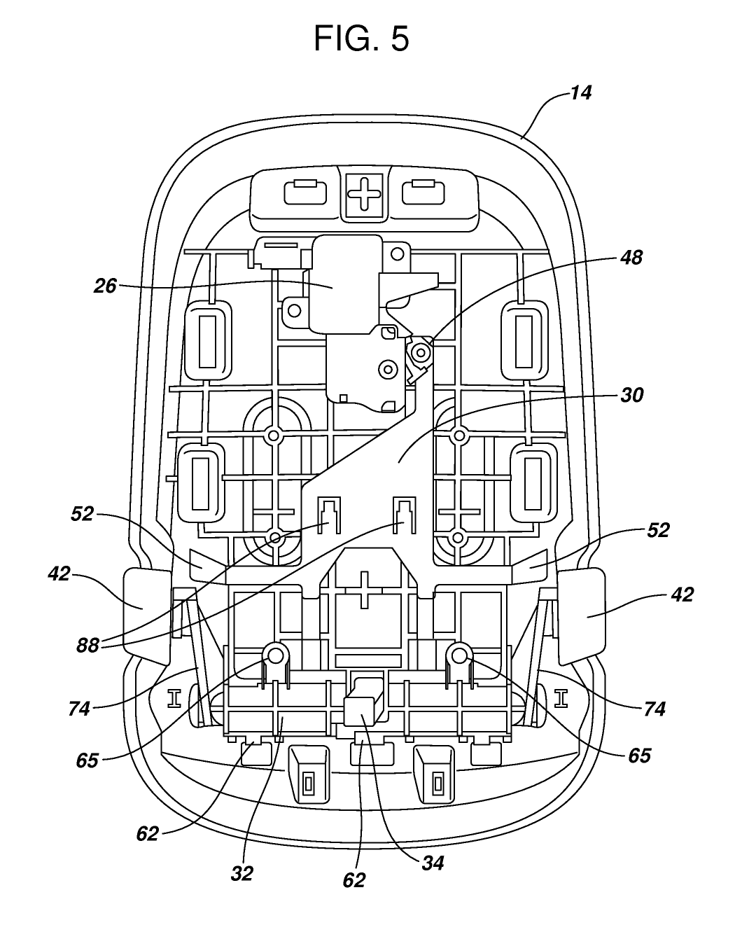

Reference is now made to FIG. 5 illustrating the blocking element 30 in the unlocked position. As should be appreciated from viewing FIG. 5, when the blocking element 30 is in the unlocked position, the rotary latch 28 is free of engagement with the locking element. Accordingly, the operator may manipulate the rotary latch 28 by engaging the paddles 42 with his fingers. In order to open the cover 14 and gain access to the interior compartment 18 of the console 10, the operator engages the control surface of the either paddle 42 and pivots the latch 28 about the axle 60 by moving the paddle toward the cover 14 (see action arrow A in FIG. 1). This rotary motion functions to release the pawl 34 from the latch striker 36. The application of continued lifting force on the either paddle 42 allows the operator to pivot the cover 14 open into the position illustrated in FIG. 2.

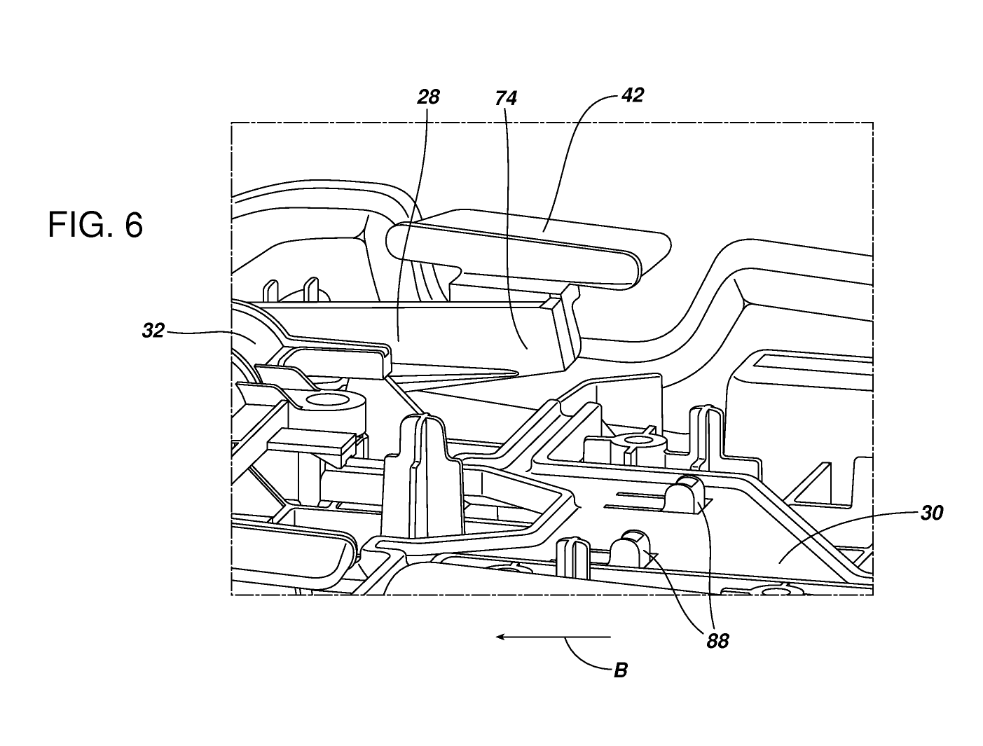

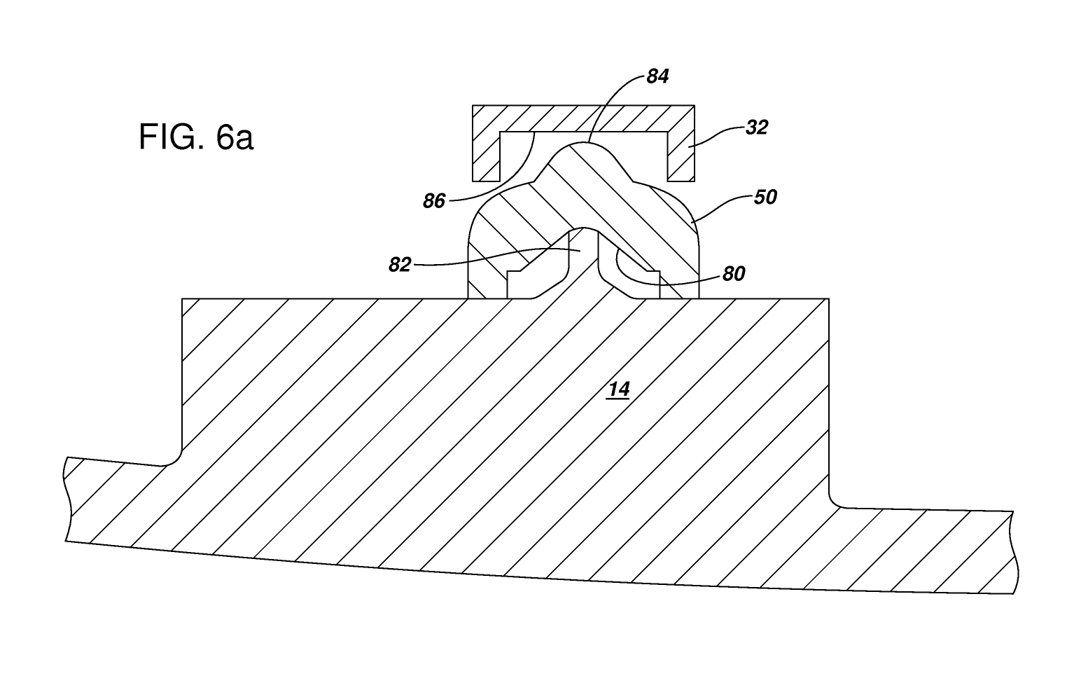

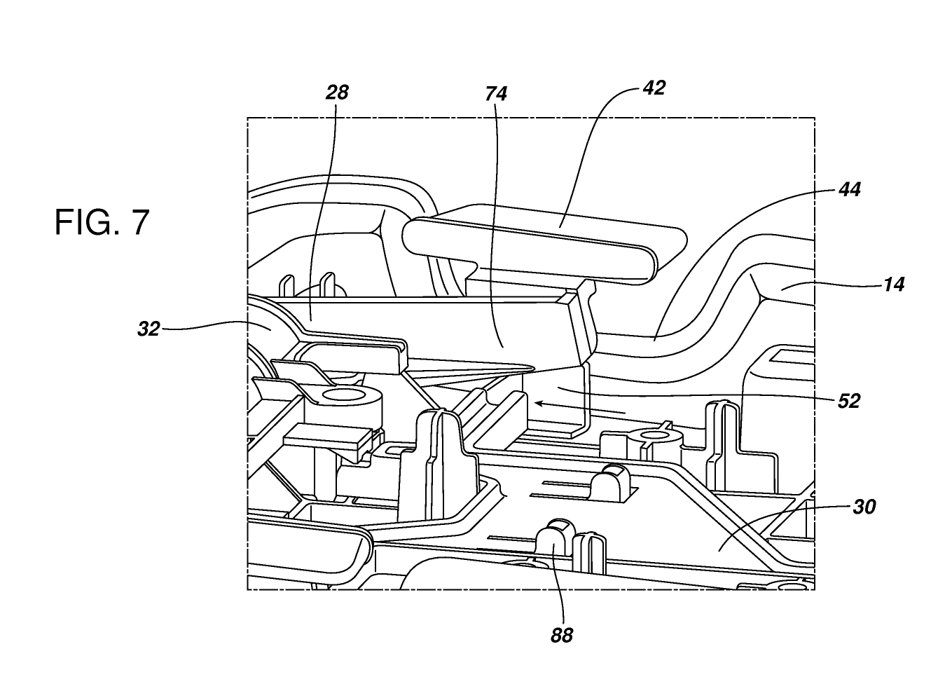

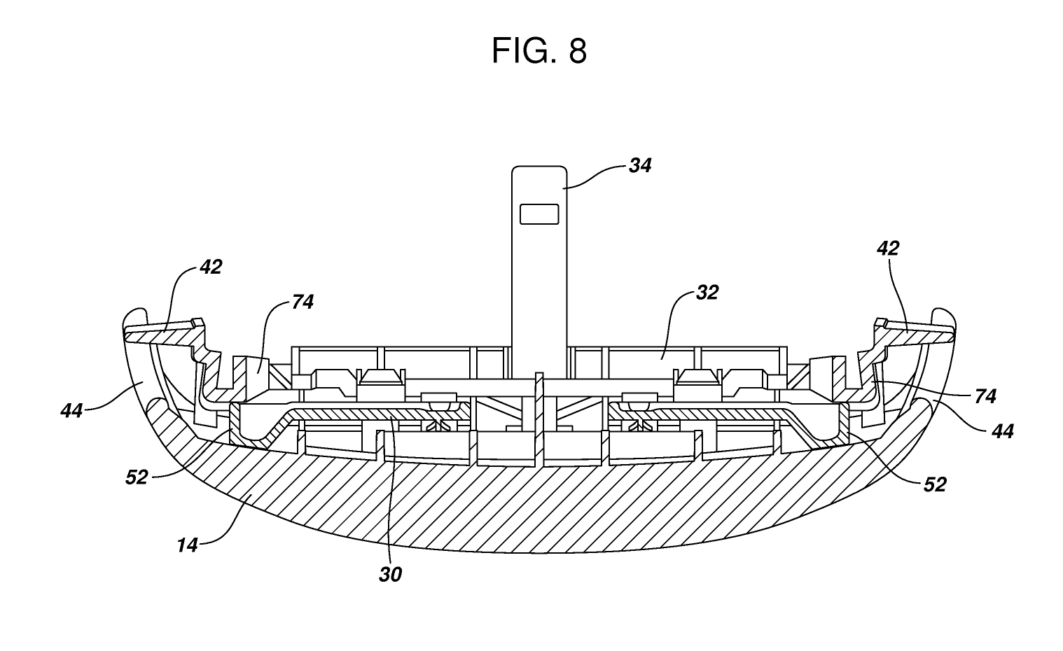

When the cover 14 is in the closed position illustrated in FIG. 1, the electronic locking assembly 20 may be activated to lock the cover in position. When this is done the actuator 26 displaces the blocking element 30 in the direction of the action arrow B in FIG. 6 so that the blocking element moves from the unlocked position illustrated in FIG. 5 to the locked position illustrated in FIGS. 7 and 8. In the locked position, the stops 52 on the blocking element 30 are positioned above the arms 74 of the rotary latch 28 that are attached to the paddles 42. As a consequence when an individual tries to rotate the rotary latch 28 by engaging the paddles 42, rotational movement is prevented by engagement of the arms 74 with the stops 52. As a consequence, the rotary latch 28 will not rotate sufficiently to release the pawl 34 from the latch striker 36 and, therefore, the cover 14 is locked and secured in the closed position.

In order to gain access to the interior compartment, the electronic locking assembly 20 must be activated to return the blocking element 30 to the unlocked position illustrated in FIG. 5 so as to provide clearance for an individual to rotate the rotary latch 28 and disengage the pawl 34 from the latch striker 36.

It should be appreciated that the blocking element 30 is supported for free translation relative to the cover 14 between the locked and unlocked position while also biased so as to prevent any rattling. More specifically, the blocking element 30 is firmly secured at one end to the actuator arm 48 and guided by the guide rails 50 at the other.

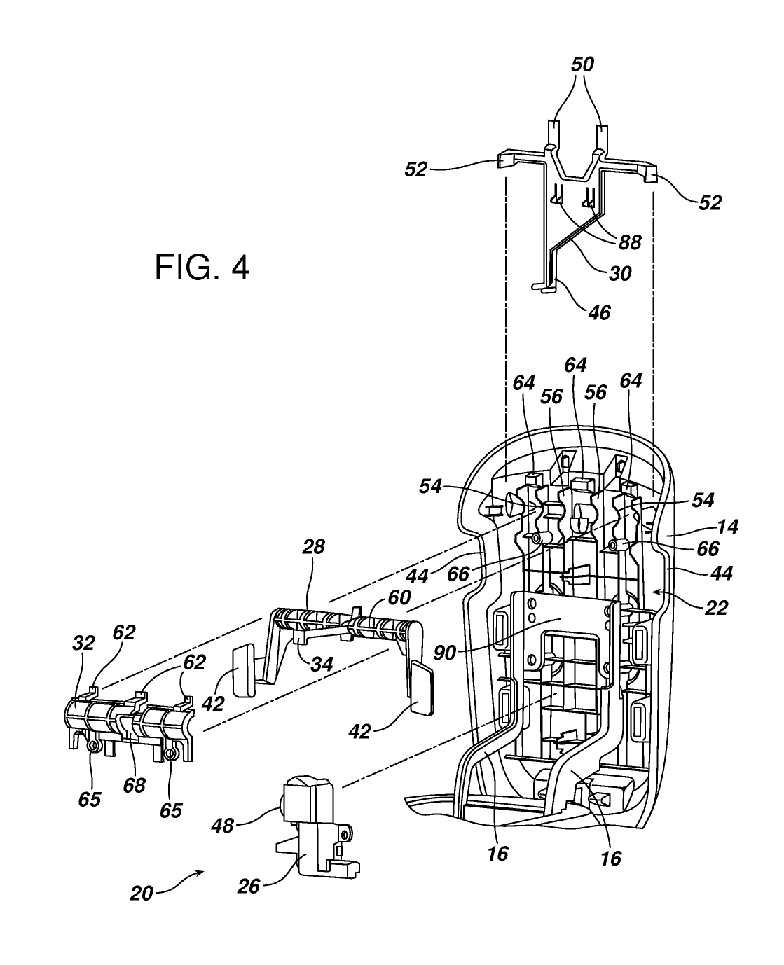

As best illustrated in FIG. 6a, the guide rails 50 each include (a) a groove 80 that receives and rides upon ribs 82 molded into the interior surface of the cover 14 and (b) a projection 84 that is received in and rides along a cooperating channel 86 formed in the shroud 32. Thus, the guide rails are captured for free sliding movement between the cover 14 and the shroud 32. Integral, molded-in springs 88 formed in the blocking element 30 engage the top surface of the hinge plate 90 and keep the element tight to the cover so as to prevent any rattling noise (see FIGS. 4, 5 and 6).

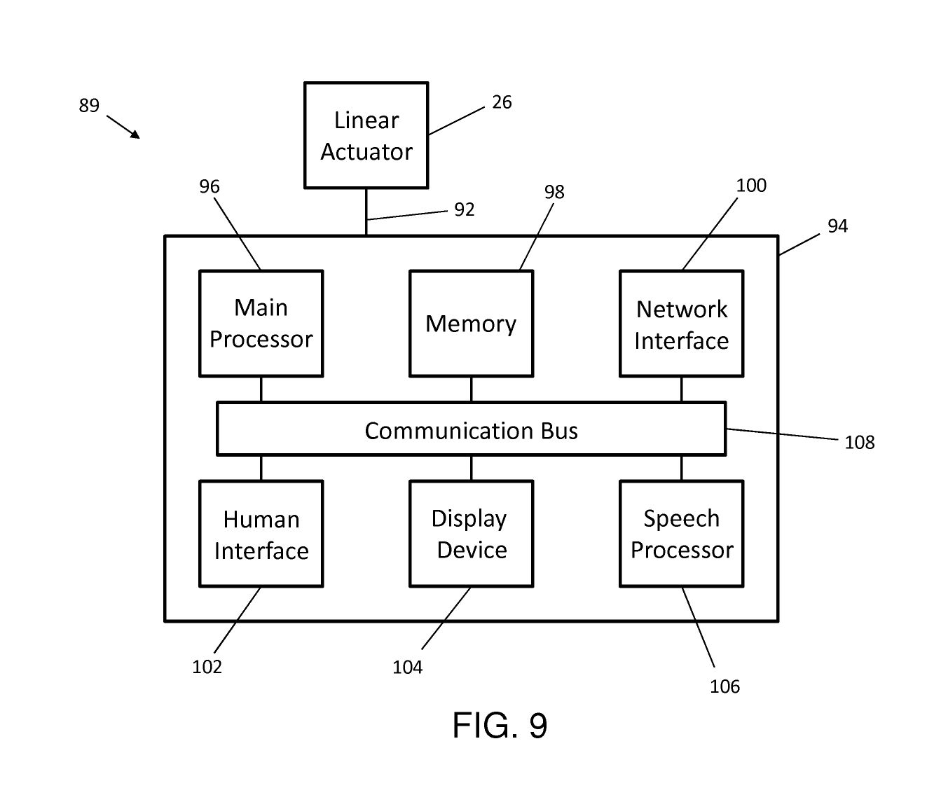

Reference is now made to FIG. 9 which is a block diagram of the mechanical control circuit 89 for the vehicle console security system. As illustrated, the linear actuator 26 is connected by control line 92 to a body control module (BCM) 94. The BCM 94 includes a computing device having a main processor 96, a memory 98, a network interface 100, a human interface 102, a display device such as a multifunction display with touchscreen capability 104 and a speech processor 106 that all communicate with each other over communication bus 108. The BCM 94 performs a number of interior body electrically based functions including, for example, interior locking, remote key entry, interior light, exterior light, windshield wiper control and the like. In some embodiments the BCM 94 may also function to control entertainment functions (e.g. radio, CD player, ETC and communications such as telephone and internet communications over a wireless network). In some embodiments the BCM 94 is connected by communication bus to other control modules that provide one or more of these additional functions.

In the illustrated embodiment, the security of the system may be controlled by requiring a code to lock and unlock the console cover 14. In one possible embodiment this is done by means of voice commands. For example the operator may state, “lock vehicle console, security code LDS 1915”. The speech processor 106 would process the voice command and operate in conjunction with the main processor 96 to provide a control signal through the control line 92 to the actuator 26 causing the blocking element 30 to be placed in the locked position. A similar voice command could be utilized to unlock the cover 14. Alternatively, the operator could utilize the touchscreen display device 104 to enter the code necessary to lock and unlock the cover 14 of the console 10. In still other embodiments the console cover 14 could be locked or unlocked remotely via wireless internet connection if desired through the network interface 100 of the BCM 94. In any the embodiments, however, it should be appreciated that the security code must be provided.

In summary, numerous benefits resolve from applying the concepts disclosed herein. Advantageously, a vehicle console security system is provided that allows an owner operator of a vehicle to securely lock 20 the cover 14 of the console 10 in position without using a key. The lock 20 may be enabled/disabled by the owner operator using a selected password. Since the lock actuator 26 is connected to and controlled by the BCM 94, the cover 14 may be locked and unlocked with the vehicle door locks if desired. The feature may be programmed in “valet mode” so that the vehicle is drivable but the cover 14 remains locked. This allows utmost security and versatility. For those who prefer, voice commands may be utilized to control operation of the locking assembly 20. In addition, in the illustrated embodiment the electronic lock assembly 20 is fully concealed from view within a cavity 22 of the cover 14 under the interior cover panel 24, thereby providing an aesthetically pleasing design that is protected from tampering.

The foregoing has been presented for purposes of illustration and description. It is not intended to be exhaustive or to limit the embodiments to the precise form disclosed. Obvious modifications and variations are possible in light of the above teachings. For example, while a rotary pawl is illustrated and described, it should be appreciated that the latch could be of a different construction including, but not necessarily limited to, a dual-pawl latch or a single pawl latch acting in planar latching geometry. All such modifications and variations are within the scope of the appended claims when interpreted in accordance with the breadth to which they are fairly, legally and equitably entitled.

What is claimed:

1. A vehicle console security system, comprising:
a console including a body, a cover and an internal compartment, said cover being displaceable between a closed position closing said internal compartment and an open position allowing access to said internal compartment; and
an electronic locking assembly mounted to said cover that locks said cover in said closed position.

2. The system of claim 1, wherein said locking assembly includes an electronic actuator and a latch.

3. The system of claim 2, wherein said latch is a rotary latch pawl.

4. The system of claim 2, further including a spring biasing said latch into a latched position.

5. The system of claim 4, further including a paddle carried on said latch, said paddle allowing one to release said latch and open said cover.

6. The system of claim 5, wherein said electronic actuator is connected to a blocking element displaceable by said actuator between a locked position and an unlocked position.

7. The system of claim 6, wherein in said locked position, said blocking element engages said latch so as to prevent release of said latch and opening of said cover.

8. The system of claim 7, wherein said electronic actuator is a linear actuator housed within a cavity on an underside of said cover.

9. The system of claim 8, wherein said cover is an armrest.

10. The system of claim 9, further including a guide cam mounted to said body and a cooperating guide rail on said blocking element.

11. The system of claim 10, wherein said blocking element includes two, parallel projecting guide rails and two aligned projecting stops.

12. The system of claim 11, further including a shroud for holding and capturing said latch between said shroud and said cover.

13. The system of claim 12, wherein said guide cam is provided on said shroud.

14. The system of claim 9, wherein said actuator is operatively connected to a control module.

15. The system of claim 14, wherein said control module includes a computing device.

16. The system of claim 15, wherein said control module includes a speech processor allowing voice commands to lock and unlock said cover.

17. The system of claim 15, wherein said control module includes a human interface allowing an operator to enter a code to lock and unlock said cover.

18. The system of claim 17, wherein said human interface comprises a monitor including a touch screen for entering said code.

19. The system of claim 1, wherein said electronic lock assembly is fully concealed from view when said cover is in said closed position.

20. The system of claim 1, wherein said cover is connected by a hinge to said body.
